(19) United States
(12) Patent Application Publication
(10) Pub. No.: US 2015/0161332 A1
(43) Pub. Date: Jun. 11, 2015

(54) MULTI-PATIENT DATA VISUALIZATION SYSTEM AND METHOD

(71) Applicant: Cardiac Pacemakers, Inc., St. Paul, MN (US)

(72) Inventors: Howard D. Simms, JR., Shoreview, MN (US); Viktoria A. Averina, Roseville, MN (US); Maya Bhat, Saint Paul, MN (US)

(21) Appl. No.: 14/561,005

(22) Filed: Dec. 4, 2014

Related U.S. Application Data
(60) Provisional application No. 61/912,937, filed on Dec. 6, 2013.

(51) Int. Cl. G06F 19/00; G06Q 50/22

(52) U.S. Cl. CPC G06F 19/322; G06Q 50/22

(57) ABSTRACT

A system and method for displaying patient data is described. Such patient data includes a list of patients with a plurality of clinical variables associated with each patient. The patient data is displayed in a manner that enables a clinical user to quickly and easily identify patients from an entire follow-up cohort based on visual evaluation.

### CLAIM OF PRIORITY

This application claims the benefit of priority under 35 U.S.C. §119(e) of U.S. Provisional Patent Application Ser. No. 61/912,937, filed on Dec. 6, 2013, which is herein incorporated by reference in its entirety.

### BACKGROUND

Present approaches to exception-based patient management typically involve creating alerts on a per-patient basis, using the data collected for each patient. Creating algorithms for automated alerts that combine multiple signals, however, is an expensive and a time-consuming process that requires clinical studies to develop and validate.

### BRIEF DESCRIPTION OF THE DRAWINGS

FIGS. 1A and 1B illustrate examples of systems for acquiring and displaying patient data.

FIG. 2 illustrates a display of patient data in the form of a two-dimensional scatter plot and a selection of a specified group of patients.

FIG. 3 illustrates an example of two-dimensional scatter plots where the axes represent a heart sound based risk index and a heart rate variability index and with certain patients highlighted in a region of interest.

FIG. 4 illustrates an alternative for the list of patients brought up in the detailed data display.

FIG. 5 shows an example of a check list of patient characteristics that a user may use to turn layers on or off.

FIG. 6 shows an example of a data collection progress graph.

FIG. 7 illustrates a scatter plot that shows the path that specific patient data points have taken since the last follow-up or after a specified time has elapsed with certain points highlighted based on a user-specified threshold.

FIG. 8 shows an example of a histogram for displaying patient data.

FIG. 9 shows an embodiment for displaying clinical variables whose values vary with time for a population of interest.

### DETAILED DESCRIPTION

Described herein are a system and method for displaying patient data, including calculated measurements, for all of a physician's patients or subgroups of their patients without executing an algorithm. Such patient data includes a list of patients with a plurality of clinical variables associated with each patient. The patient data is displayed in a manner that enables a clinical user to quickly and easily identify patients from an entire follow-up cohort based on visual evaluation. In certain embodiments, a larger population of patients could be displayed for reference (beyond just the physician's patients or the physician's clinic). These other patients could be patients with specific disorders or symptoms, patients who have been hospitalized, or patients with other specified characteristics. In some embodiments, the system would only provide the data points for context, and the specific identity of the patients from other clinics would not be accessible to a system user.

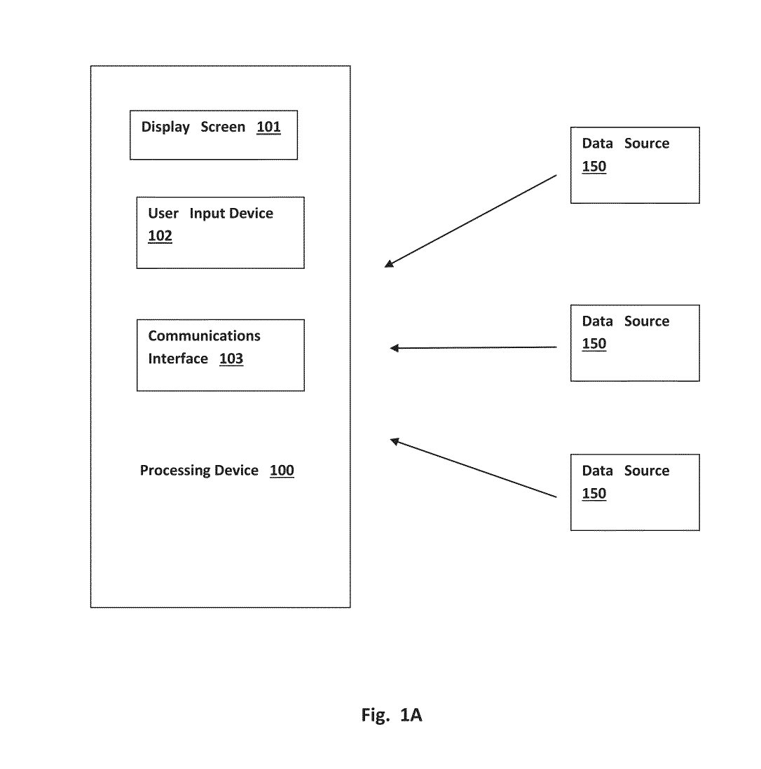

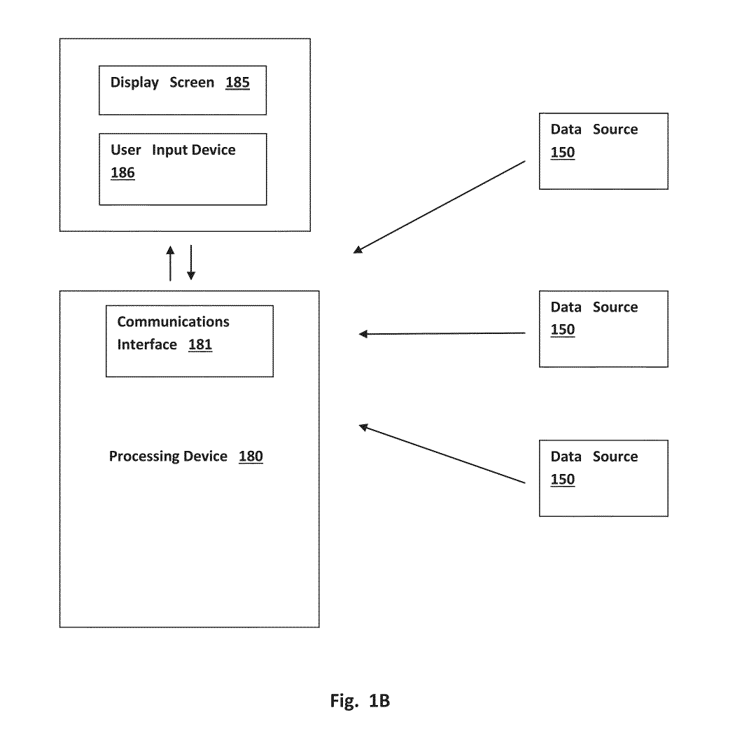

FIG. 1A illustrates an example of a system that includes a processing device 100 operated by a clinical user to display patient data in accordance with various embodiments as described below. The device 100 includes a display screen 101, a user input device 102 (e.g., a keyboard, mouse, and/or touch screen input), and a communications interface 103 for receiving patient data from one or more data sources 150. The processing device may be, for example, a mobile device (e.g., tablet, smart phone, portable computer) or other type of computer (e.g., a medical device programmer) that communicates wirelessly or via direct connection with a data source 150. A data source 150 may be, for example, a database server for storing patient data (e.g., electronic medical records) received from multiple sources that is communicated to the processing device 100 via a network connection or a portable storage device that loads data directly into the processing device. Data sources 150 may also be patient devices that collect data directly from an individual patient such as implantable devices (e.g., cardiac pacemakers) or wearable data recorders (e.g., Holier monitors) that transmit their data directly to the processing device 100 and/or a database server.

FIG. 1B illustrates an alternate embodiment of a system that includes a processing device 180 that is separate from a display unit 185 and user input device 186. For example, the data processor 180 could be a remote server, bedside monitor, or other type of monitoring device. A communications interface 181 enables the processor 180 to communicate (e.g., wirelessly) with the display unit 185 and input device 186. The communications interface 181 may also enable communications with one or more data sources 150. The data obtained from the data processor 180 could then be displayed interactively on the display unit 185 which could be, for example, a mobile device or traditional computer.

The displaying of patient data in response to user inputs may be performed, for example, by an application executed by the processing device that retrieves data previously stored in the device or retrieves data from a server in accordance with the user is input. In latter case, for example, the system fir displaying patient data may be implemented as a web browser or other Internet application that retrieves data selected by the user input from a server. As described more fully below, a user/clinician may select to display a particular subset of the total amount of accessible patient data, which patient data may be displayed in a number of different ways. The patient data may be filtered to produce the desired subset which may include, for example, only particular clinical variables and/or only particular patients or patient types. From the resulting graphical display of patient data, the user/clinician may further select a group of patients for a more detailed review by, for example, manually defining a region of interest on the display screen that includes only patients whose clinical variable values are within particular ranges. In one embodiment, patient data for the entire patient population (health care system level, country level, worldwide) may be displayed all at once, but a particular clinician has access to detailed information only tier his/her patients. The displayed patient data may include, for example, graphical display of clinical variable values, lists that can be expanded or collapsed, and pictures.

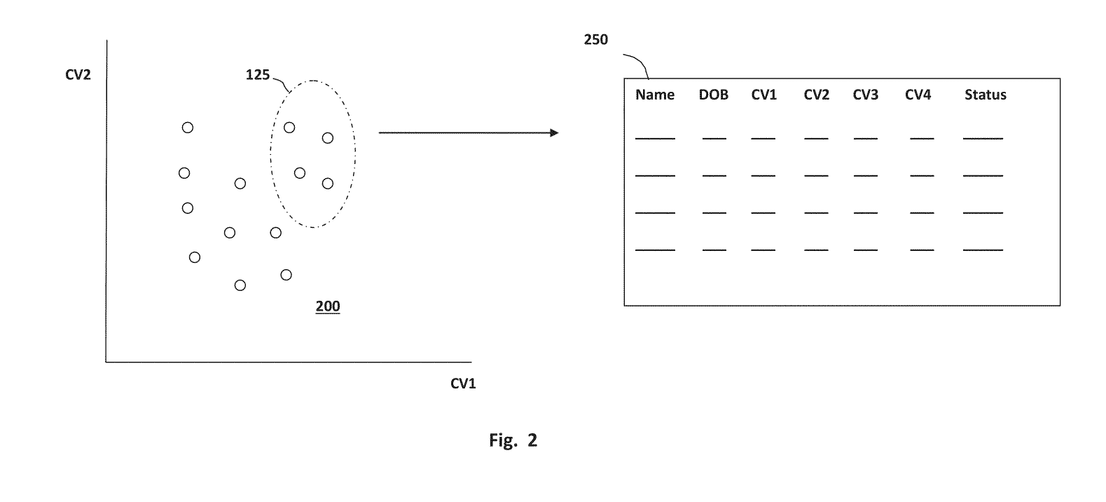

FIG. 2 illustrates a display of patient data in the form of a two-dimensional scatter plot 200 for a group of patients. Each point in the scatter plot represents a patient, and each axis is a clinical variable (e.g. a risk factor). The coordinates of each point in the space defined by the axes are then the values of the clinical variables CV1 and CV2 associated with the patient represented by the point. Similarly, a surface plot could be shown in a three-dimensional display (e.g., a perspective view) with axes representing three different clinical variables. A user may select a region of interest in the scatter plot by drawing (e.g., by touch screen or mouse input) a shape 225 that encloses (or nearly encloses) particular points. The shape for enclosing the points may be an oval, rectangle, or any arbitrary freehand shape. Alternatively, the region of interest may be defined by inputting ranges of clinical variables to select certain patients having clinical variable values within those ranges. For example, assume that X and Y are clinical variables and that arbitrary values for those variables are represented by x and y , respectively. The user could request that the system display patients with X>x. The selected ranges could also be further specified with logical AND or OR relationships such as a display of patients with X>x AND Y<y.

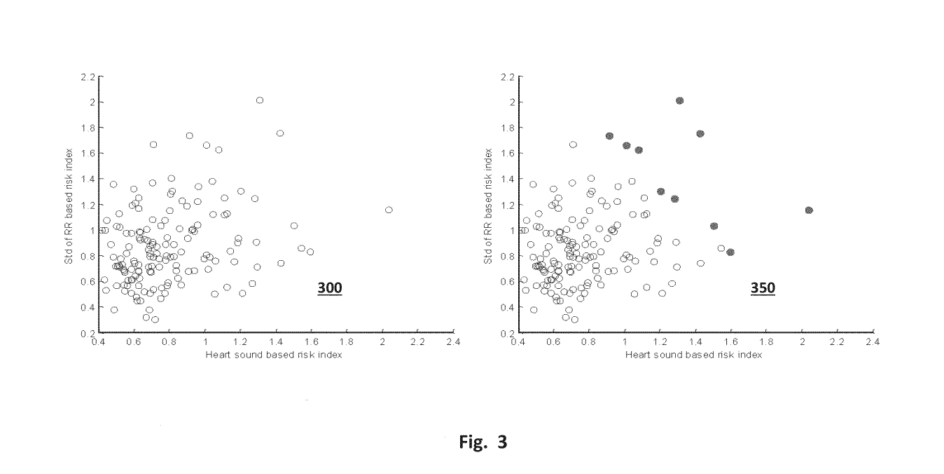

After the region of interest is defined, a list 250 of the selected patients is displayed along with detailed data which may include more clinical variables than are represented in the scatter plot such variables CV1 through CV4 as illustrated by the figure. Other information such as clinical status may also be displayed. The list of patients may then be sorted by any of the displayed variables. FIG. 3 illustrates an example of two-dimensional scatter plots 300 and 350 where the axes represent a heart sound based risk index and a heart rate variability (i.e., RR interval variability) index that have been shown to be strong risk stratifiers with respect to cardiac events. The solid points shown in Fig. 350 depict those patients having a high degree of cardiac risk predicted by the two risk indices and may therefore be selected for more detailed display.

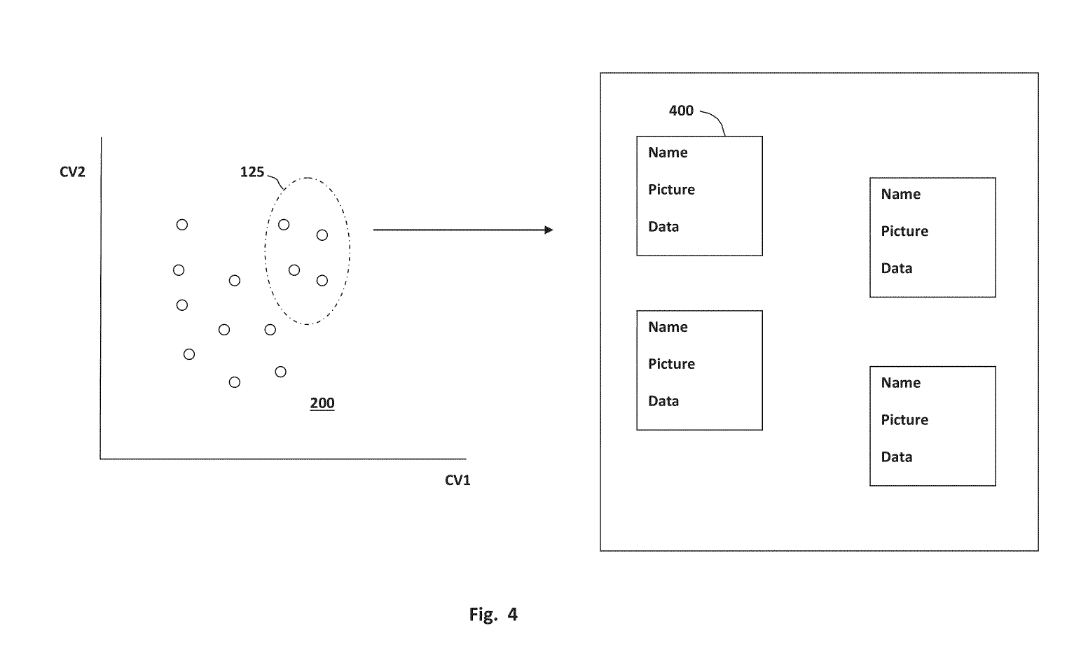

FIG. 4 illustrates an alternative for the list of patients brought up in the detailed data display for the selected patients in FIG. 2. In this embodiment, a detailed patient data block 400 is shown for each selected point of the scatter plot. The patient data block may include the patient name, picture, and a list of clinical variable values associated with the patient.

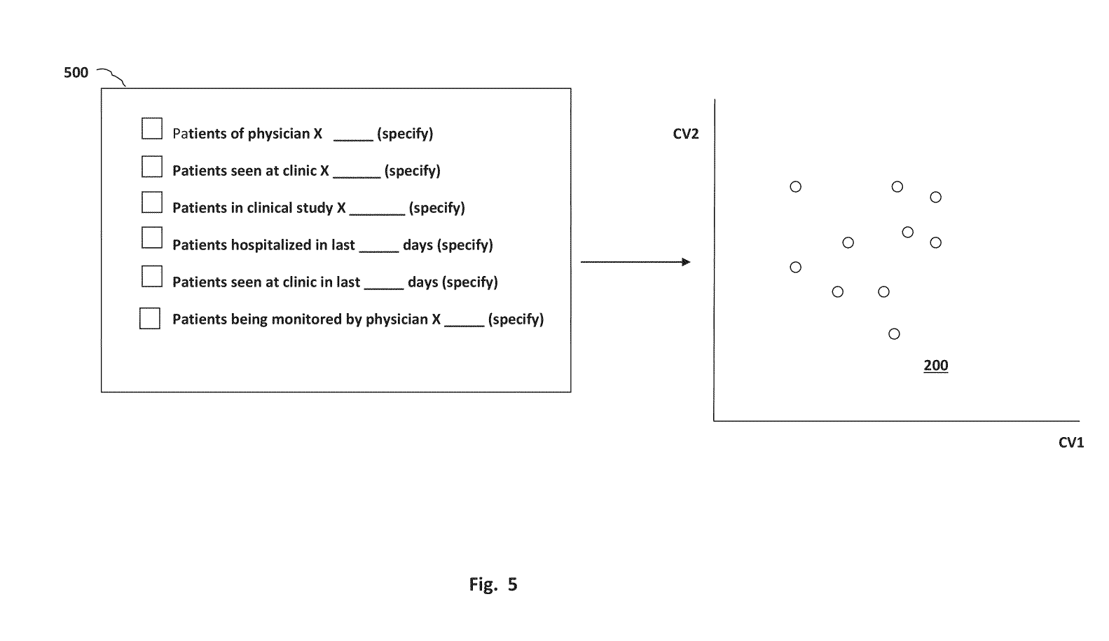

The patient data points that are displayed can be filtered using selectable layers, plus possible color coding. The filters can also include user-adjustable characteristics that may be any of clinical variables associated with the patients. FIG. 5 shows an example of a check list 500 of patient characteristics that a user may select by checking a box to turn layers on or off. The layers may be defined as, for example, those patients that are: treated by particular physician, being seen at a particular clinic, taking part in a particular study, hospitalized during some time period (e.g., the last 30 days), seen in a clinic during some time period (e.g., in the last two weeks), and/or patients being monitored by a particular physician.

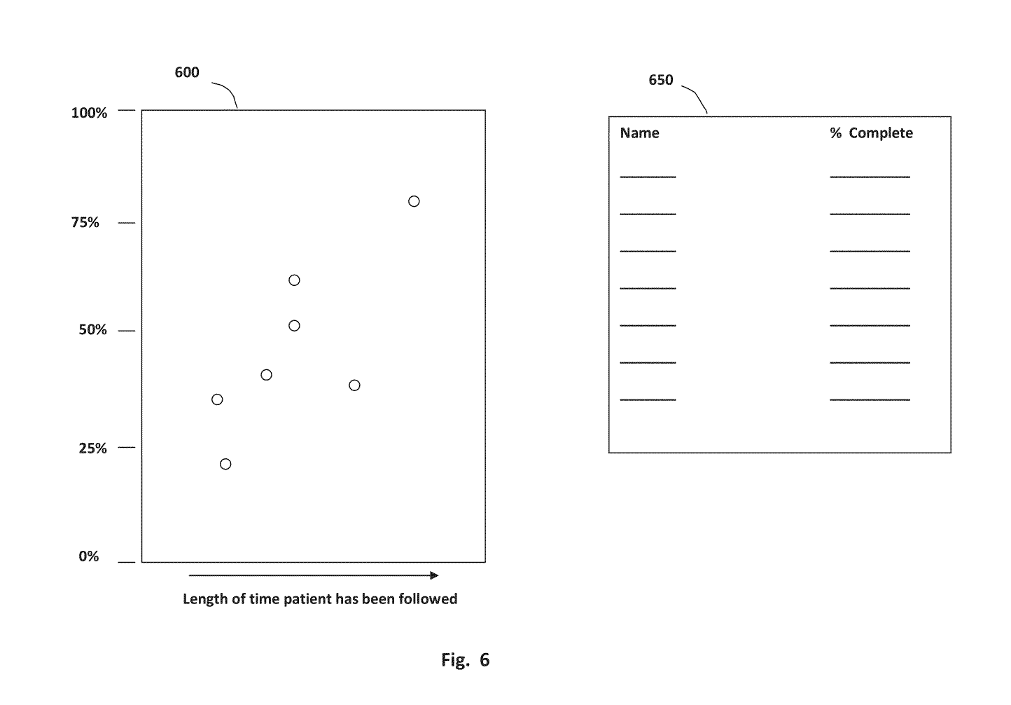

Some clinical variables that require data to be collected for some time prior to being able to display a data point (e.g., 30 days of data to calculate a risk index). In one embodiment, when the displayed subset of the patient data includes one or more such 1.5 clinical variables, those patients for whom more data still needs to be collected in order to derive the clinical variable are not shown (e.g., are not represented as points in the scatter plot). The user is able to call up a progress graph, however, that shows those patients that are still pending completion of initial data collection or who have missing data. FIG. 6 shows an example of such a progress graph 600 where each patient is represented by a point plotted in space defined by the two axes. The horizontal axis represents the time that the patient has been in the system (i.e., the length of time the patient has been followed and has had data collected from.). The vertical axis indicates the percentage of data that has been collected thus far. The user may select particular points in the graph to display detailed information such as the patient's identity and other information. Either instead of, or in addition to, the progress graph 600, a progress list 650 may be displayed that lists each patient still needing to complete data collection along with the percentage of data that has so far been collected.

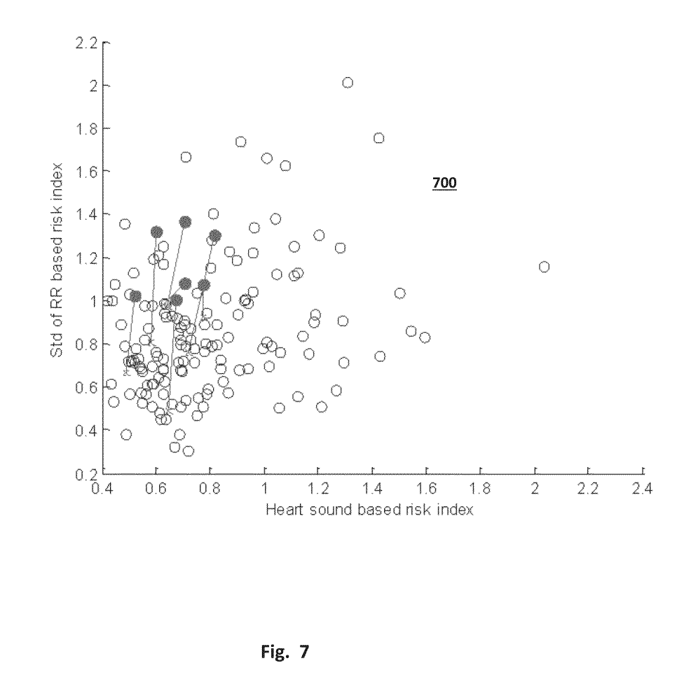

Another embodiment is illustrated by the scatter plot 700 shown in FIG. 7. The scatter plot 700 shows the path that specific patient data points have taken since the last follow-up or after a specified time has elapsed. Points are highlighted based on a user-specified threshold of the amount of distance moved during the time of interest. A user is thus able to identify a boundary for a clinical variable so that the display highlights patients that have crossed that boundary over a user-specified period of time or since the last follow-up. Alternatively, the user can specify an absolute or percentage change in the value of the clinical variable to highlight data points. The highlighting of the patient points may be done by coloring, filling, or otherwise distinguishing particular points in the scatter plot. The scatter plot may also include “tracks” for the highlighted patient points that show the change in clinical variable value. In the example shown in FIG. 7, an X marks the initial location of the highlighted point, and the filled circle shows its current location in the clinical variable space. The display can also be filtered to de-clutter the presented data (e.g., by layering)

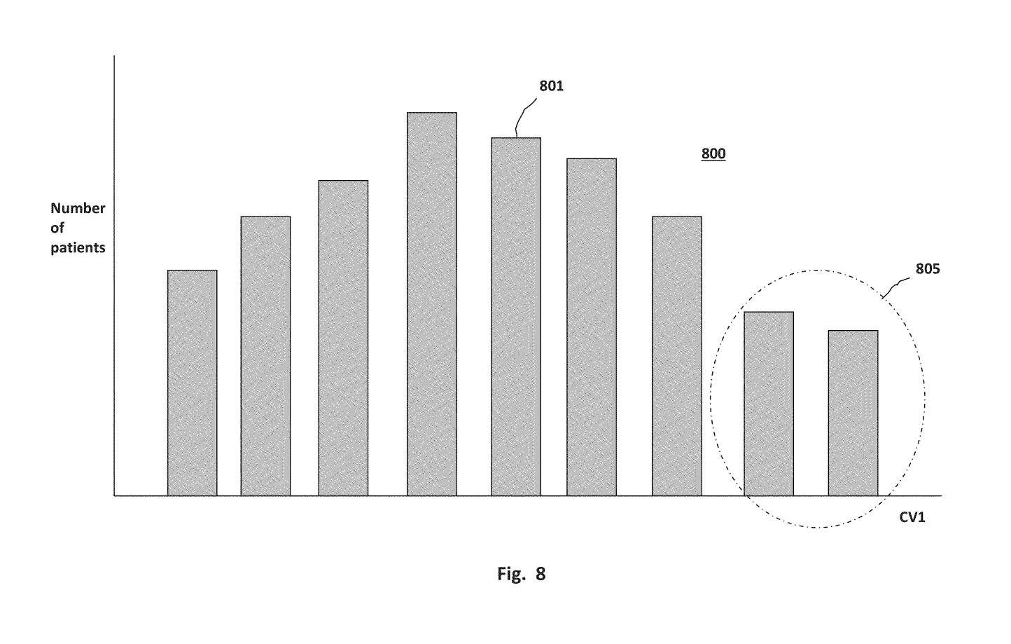

Either in addition to, or instead of, the scatter plot discussed above, patient data may also be displayed in the form of a histogram. FIG. 8 shows an example of a histogram 800 made up of a plurality of bars 801. The width and location of a bar with respect to the horizontal axis indicates a range of a selected clinical variable value, and the height of the bar with respect to the vertical axis shows the number of patients having values of the clinical variable within the range. All of the display functionalities discussed previously with respect to scatter plots may also be performed for the histogram representation of patient data. For example, a region or regions of interest 805 may be drawn around one or more of the bars to call up detailed data displays for the bar or bars contained within.

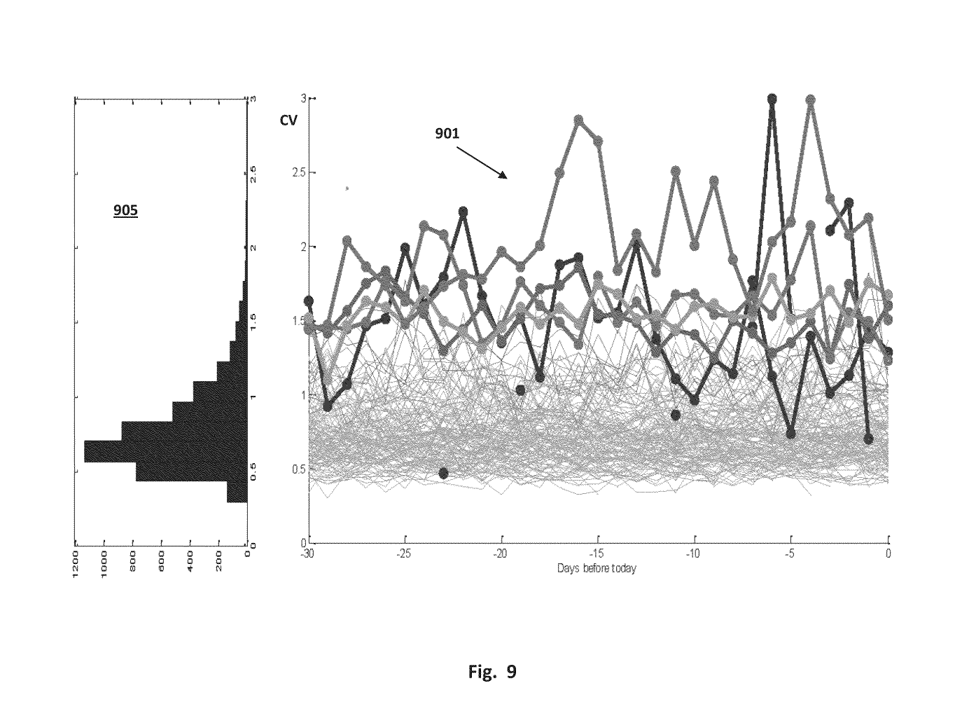

In another embodiment, for clinical variables whose values vary with time, patient data may be displayed as individual graphs of a selected clinical variable value versus time for each patient. FIG. 9 shows an example of such a display made up of such graphs 901 where time t is indicated by the horizontal axis and the value of the clinical variable CV is indicated by the vertical axis. A histogram 905 may be shown alongside the display of graphs to indicate the number of patients represented by the graphs 901 within particular ranges of the clinical variable. In this example, time-varying signal data is shown for all patients at once, and the user can highlight those signals that are deemed to be of interest compared to the rest of the population. Alternatively, the user can specify a threshold of interest to highlight those patients that have exceeded the threshold. Such highlighting may be done by color coding the highlighted graphs or otherwise distinguishing them from the non-highlighted graphs.

This application is intended to cover adaptations or variations of the present subject matter. It is to be understood that the above description is intended to be illustrative, and not restrictive. The subject matter has been described in conjunction with the foregoing specific embodiments. It should be appreciated that those embodiments may also be combined in any manner considered to be advantageous. Also, many alternatives, variations, and modifications will be apparent to those of ordinary skill in the art. Other such alternatives, variations, and modifications are intended to fall within the scope of the following appended claims.

What is claimed is:

1. A system for displaying patient data, comprising:
a processing device;
a display and user input device interfaced to the processing device;
wherein the processing device is configured to:
receive patient data from an external data source, wherein the patient data includes a list of patients with a plurality of clinical variables associated with each patient;
receive one or more user-selected clinical variables via the user input;
display one or more axes that each represent one of the user-selected clinical variables;
display a subset of the patient data as a representation of the listed patients depicted in a space defined by the one or more axes according to the value of the user-selected clinical variable(s) associated with each patient;
receive via the user input device a selected range for one or more of the user-selected clinical variables; and,
display detailed data for each of the listed patients whose associated clinical variables are within the selected range.

2. The system of claim 1 wherein the processing device is configured to receive the selected range for the one or more of the user-selected clinical variables as a region of interest drawn on the display.

3. The system of claim 1 wherein the processing device is configured to receive the selected range for the one or more of the user-selected clinical variables as a numerical input.

4. The system of claim 1 wherein the representation of the listed patients is a scatter plot of data points in the space defined by the one or more axes with each data point representing a patient and having coordinates that correspond to the values of the clinical variables associated with that patient.

5. The system of claim 1 wherein the representation of the list of patients is a histogram plotted against the one or more axes showing the number of patients having associated clinical variable values corresponding to coordinates of the one or more axes.

6. The system of claim 1 wherein the patient data includes values of clinical variables measured at different times and wherein the representation of the list of patients is, for each such patient, the values of one or more clinical variables associated with that patient plotted against a time axis.

7. The system of claim 1 wherein the processing device is configured so that the patient data subset may be filtered in accordance with a user input to display a desired layer of the subset that includes only patients with particular characteristics.

8. The system of claim 7 wherein the processing device is configured to provide a check list of patient characteristics that a user may select by checking a box to turn layers on or off.

9. The system of claim 7 wherein the layers are defined to include patient characteristics selected from a group that include those patients who are: treated by a particular physician, being seen at a particular clinic, taking part in a particular study, hospitalized during some time period (e.g., the last 30 days), seen in a clinic during some time period (e.g., in the last two weeks), and being monitored by a particular physician.

10. The system of claim 1 wherein the processing device is configured to, for clinical variables that require data to be collected for some time prior to being displayable, display a progress graph or progress list that shows those patients that are still pending completion of initial data collection or who have missing data.

11. The system of claim 4 wherein the processing device is configured to accept a user input that identifies a boundary for a clinical variable and to display highlighted data points for those patients whose clinical variable values have crossed that boundary over a user-specified period of time.

12. The system of claim 4 wherein the processing device is configured to accept a user input that identifies a specified change amount for a clinical variable and to display highlighted data points for those patients whose clinical variable values have changed by at least the specified change amount over a user-specified period of time.

13. The system of claim 4 wherein the processing device is configured to display tracks for particular data points that show how the clinical variable value has changed.

14. A method for displaying patient data, comprising:
receiving patient data from an external data source, wherein the patient data includes a list of patients with a plurality of clinical variables associated with each patient;
receiving one or more user-selected clinical variables via a user input;
displaying one or more axes that each represent one of the user-selected clinical variables;
displaying a subset of the patient data as a representation of the listed patients depicted in a space defined by the one or more axes according to the value of the user-selected clinical variable associated with each patient;
receiving via the user input a selected range for one or more of the user-selected clinical variables; and,
displaying detailed data for each of the listed patients whose associated clinical variables are within the selected range.

15. The method of claim 14 further comprising receiving the selected range for the one or more of the user-selected clinical variables as a region of interest drawn on the display.

16. The method of claim 14 further comprising receiving the selected range for the one or more of the user-selected clinical variables as a numerical input.

17. The method of claim 14 wherein the representation of the listed patients is a scatter plot of data points in the space defined by the one or more axes with each data point representing a patient and having coordinates that correspond to the values of the clinical variables associated with that patient.

18. The method of claim 14 wherein the representation of the list of patients is a histogram plotted against the one or more axes showing the number of patients having associated clinical variable values corresponding to coordinates of the one or more axes.

19. The method of claim 14 wherein the patient data includes values of clinical variables measured at different times and wherein the representation of the list of patients is, fur each such patient, the values of one or more clinical variables associated with that patient plotted against a time axis.

20. The method of claim 14 further comprising filtering the patient data subset in accordance with a user input to display a desired layer of the subset that includes only patients with particular characteristics.
